(19) United States
(12) Patent Application Publication
(10) Pub. No.: US 2024/0411987 A1
(43) Pub. Date: Dec. 12, 2024

(54) DOCUMENT PROCESSING METHOD AND APPARATUS, AND ELECTRONIC DEVICE

(71) Applicant: BEIJING ZITIAO NETWORK TECHNOLOGY CO., LTD., Beijing (CN)

(72) Inventor: Liping LI, Beijing (CN)

(21) Appl. No.: 18/737,879

(22) Filed: Jun. 7, 2024

(30) Foreign Application Priority Data
Jun. 9, 2023 (CN) 202310685778.X

(51) Int. Cl. G06F 40/205; G06F 16/958

(52) U.S. Cl. CPC G06F 40/205; G06F 16/958

(57) ABSTRACT

The present disclosure provides a document processing method and apparatus, and an electronic device. A specific implementation of the method comprises: receiving a triggering operation for a target document output by a target client, the target document comprising a first object and a second object, and the first object comprising a first content of a first component. In response to the triggering operation, rendering the first object by using a front-end control in the target client; and rendering the second object by using the target client, wherein the second object comprises a second content of a second component. The implementation achieves a partial same-layer rendering. Thus when the problem of mutual coverage between a native component and a webpage component is reduced, a decrease in the quality and efficiency of rendering is reduced, and the impact on some functions of the native components is also reduced.

### CROSS-REFERENCE TO RELATED APPLICATION(S)

This application claims priority to Chinese Application No. 202310685778.X filed Jun. 9, 2023, the disclosure of which is incorporated herein by reference in its entity.

### FIELD

The present disclosure relates to the technical field of computer software, and in particular, to a document processing method and apparatus, and an electronic device.

### BACKGROUND

When a user opens a document output by a client, the document is usually rendered by a front-end control embedded in the client. However, the document may comprise one or more native components created by the client, and rendering the native components in the document by the front-end control has certain limitations, which can affect some of the functions of the native components. At present, there is a need for a method for rendering a document.

### SUMMARY

The present disclosure provides a document processing method and apparatus, and an electronic device.

In a first aspect, a document processing method is provided. The method comprises:
receiving a triggering operation for a target document, wherein the target document is output by a target client, the target document comprises a first object and a second object, and the first object comprises a first content of a first component;
in response to the triggering operation, rendering the first object by using a front-end control in the target client; and
rendering the second object by using the target client, wherein the second object comprises a second content of a second component.

In a first aspect, a document processing apparatus is provided. The apparatus comprises:
a receiving module, configured to receive a triggering operation for a target document, wherein the target document is output by a target client, the target document comprises a first object and a second object, and the first object comprises a first content of a first component;
a first rendering module, configured to: in response to the triggering operation, render the first object by using a front-end control in the target client; and
a second rendering module, configured to render the second object by using the target client, wherein the second object comprises a second content of a second component.

In a third aspect, a computer-readable storage medium is provided. The computer-readable storage medium has a computer program stored thereon. The computer program, when run by a processor, implements any method in the first aspect.

In a fourth aspect, an electronic device is provided. The electronic device comprises a memory, a processor, and a computer program stored in the memory and runnable on the processor. The processor, when running the program, implements any method in the first aspect.

The technical solutions provided by the embodiments of the present disclosure can comprise the following beneficial effects. According to the document processing method and apparatus provided by the embodiments of the present disclosure, when the target document output by the target client is rendered, the front-end control in the target client is used to render a first content of a portion of native components, and the target client is used to render a second content of another portion of the native components, thus achieving a partial same-layer rendering. Thus when the problem of mutual coverage between a native component and a webpage component is reduced, a decrease in the quality and efficiency of rendering is reduced, and the impact on some functions of the native components is reduced.

It should be understood that the foregoing general descriptions and the following detailed descriptions are merely for illustration and explanation purposes and are not intended to limit the present disclosure.

### BRIEF DESCRIPTION OF THE DRAWINGS

To describe the technical solutions in the embodiments of this specification more clearly, the following briefly describes the accompanying drawings required for describing the embodiments. Apparently, the accompanying drawings in the following description show merely some embodiments of this specification, and a person of ordinary skill in the art may still derive other drawings from these accompanying drawings without creative efforts.

FIG. 1 is a schematic diagram of an exemplary system architecture applying embodiments of the present disclosure;

FIG. 2 is a flowchart of a document processing method shown according to an exemplary embodiment;

FIG. 3 is a block diagram of a document processing apparatus shown according to an exemplary embodiment;

FIG. 4 is a schematic block diagram of an electronic device according to some embodiments of the present disclosure;

FIG. 5 is a schematic block diagram of another electronic device according to some embodiments of the present disclosure; and

FIG. 6 is a schematic diagram of a storage medium according to some embodiments of the present disclosure.

### DETAILED DESCRIPTION OF EMBODIMENTS

In order to make a person skilled in the art to better understand the technical solutions of this specification, the technical solutions in the embodiments of this specification are described clearly and completely below with reference to the accompanying drawings in the embodiments of this specification. Apparently, the described embodiments are merely some rather than all of the embodiments of this specification. All other embodiments obtained by a person of ordinary skill in the art based on the embodiments of this specification without making creative efforts shall fall within the protection scope of this specification.

When the following description involves the accompanying drawings, unless otherwise indicated, the same numerals in different accompanying drawings represent the same or similar elements. The implementations described in the following exemplary embodiments do not represent all implementations consistent with the present disclosure. On the contrary, they are only examples of apparatuses and methods consistent with some aspects of the present disclosure as detailed in the attached claims.

The terms used in the present disclosure are for the purpose of describing specific embodiments only and are not intended to limit the present disclosure. The singular forms of “one” and “the” used in the present disclosure are also intended to comprise a plural form, unless the context clearly indicates other meanings. It should also be understood that the term “and/or” used herein comprises any or all combinations of one or more related listed items.

It should be understood that although various information may be described using terms such as first, second, and third in the present disclosure, such information should not be limited to these terms. These terms are only used to distinguish information of the same type from each other. For example, without departing from the scope of the present disclosure, first information can also be referred to as second information, and similarly, second information can also be referred to as first information. Depending on the context, the term “if” used herein can be interpreted as “when” or “in response to determining that”.

Referring to FIG. 1, a schematic diagram of an exemplary system architecture applying embodiments of the present disclosure is shown.

As shown in FIG. 1, the system architecture 100 may comprise terminal devices 101 and 102, a network 103, and a server 104. The network 103 is a medium configured to provide communication links between the terminal devices 101, 102 and the server 104. The network 103 may comprise various connection types, such as wired and wireless communication links or optical cables.

The terminal devices 101 and 102 may interact with the server 104 through the network 103 to receive or send messages or information. The terminal devices 101 and 102 may be various electronic devices that comprise but are not limited to smart phones, tablets, laptops, desk computers, and the like. The server 104 may be a server that provides various services, for example, a server that provides document services. The server may store, analyze, and process received data. It can be understood that one server can provide one or more services, and the same service can also be provided by a plurality of servers.

It should be understood that the quantities of the terminal devices, the networks, and the servers in FIG. 1 are only illustrative. According to implementation requirements, there may be any number of terminal devices, networks, and servers.

Based on the system architecture shown in FIG. 1, in the embodiments of the present disclosure, the terminal device 101 or the terminal device 102 is installed with client ‘a’, and client ‘a’ may be configured to manage a document. A browser (such as webview, etc.) is embedded in the client ‘a’ as a front-end control. The terminal device 101 or the terminal device 102 may obtain document ‘b’ from the server 104 through the network 103 and output document ‘b’ through client ‘a’. A user may open the document ‘b’ by performing a triggering operation for the document ‘b’. Document ‘b’ comprises a preset type of content to be presented. The content to be presented is a content of a specified native component (for example, the preset type of content to be presented may be a file embedded in a content block). The front-end control embedded in the client ‘a’ may be used to render the content to be presented. Document ‘b’ may further comprise content to be presented corresponding to a webpage component, and the content to be presented corresponding to the webpage component may be rendered by the front-end control. Document ‘b’ may further comprise content to be presented of other native components, and the content to be presented of other native components may be rendered by the client.

The present disclosure will be described in detail below in combination with specific embodiments.

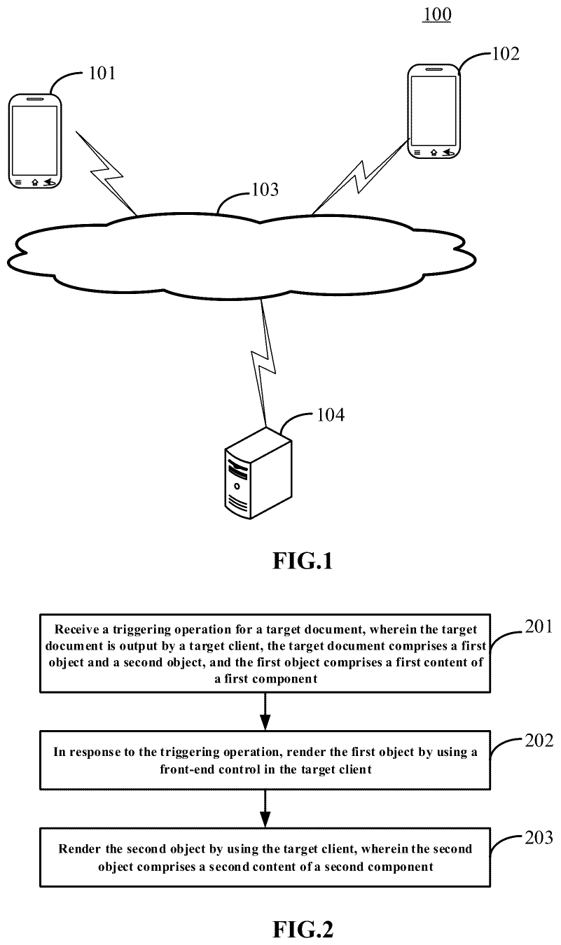

FIG. 2 is a flowchart of a document processing method shown according to an exemplary embodiment. The method may be applied to a terminal device. In this embodiment, for case of understanding, a terminal device that may install a third-party application program is taken as an example. Those skilled in the art can understand that the terminal device may comprise, but is not limited to, a mobile terminal device such as a smartphone, a smart wearable device, a tablet, and the like. The method may comprise the following steps.

As shown in FIG. 2, in step 201, a triggering operation for a target document is received, wherein the target document is output by a target client, the target document comprises a first object and a second object, and the first object comprises a first content of a first component.

In step 202, in response to the triggering operation, the first object is rendered by using a front-end control in the target client.

In step 203, the second object is rendered by using the target client, wherein the second object comprises a second content of a second component.

In this embodiment, the terminal device is installed with the target client, and the target client may be configured to manage a document. A browser (such as webview, etc.) is embedded in the target client as the front-end control. Before the method is performed, a partial front-end code needs to be added to the front-end control to enable the terminal device to perform the above method.

### (1) A Webpage Component is Created by Inheriting a Webpage Element

For example, the partial front-end code may be written in JavaScript language, and a webpage component may be created by inheriting HTMLElement. HTMLElement is a webpage element. This embodiment is only an example of creating the webpage component by inheriting HTMLElement. It can be understood that the webpage component may be further created by inheriting other types of webpage elements. The present disclosure will not limit this aspect.

For example, if ‘drive_file_block_v2’ is used to represent a preset string type, an operation of creating a webpage component is performed when a string type corresponding to an element in the obtained target document is ‘drive_file_block_v2’.

It should be noted that a code used for setting an operation corresponding to a human-computer interaction event, and a code used for customizing various functions and attributes of the above webpage component may be further added.

### (2) A Label is Defined for the Above Webpage Component.

For example, the label of the above webpage component may be customized by writing in JavaScript language and using a window.customElements.define function. The code snippet used for defining the label for the above webpage component may be written behind the code snippet used for creating the webpage component.

After the front-end code is added to the front-end control, when a user triggers the target document output by the target client, the terminal may execute the operations corresponding to step 201 to step 203.

Firstly, in step 201, a triggering operation for the target document is received, wherein the triggering operation for the target document may be an operation for triggering the opening of the target document. The target document is output by a target client. For example, the target document may be displayed by the target client, and the like. The target document comprises a first object and a second object.

Specifically, the first object may comprise a first content of a first component. The first component may be a native component, and a first content of the first component may be a preset type of content. For example, the first component may be a target content block in the target document, and the first content may be a file embedded in the target content block. The file may comprise, but is not limited to, a text file, a video file, an image file, and the like. This embodiment is not limited to a specific type of the file. It can be understood that the first content may also be a content of another type of components in the target document. This embodiment does not limit this aspect.

Then, in step 202, in response to the triggering operation, the first object is rendered by using a front-end control in the target client.

In this embodiment, the first object may be rendered by using the front-end control. It should be noted that the target document may further comprise a third object. The third object may comprise a content of the webpage component. The third object may also be rendered by using the front-end control. Specifically, the front-end control may obtain target parsed data based on the target document, and then render the first object and the third object based on the target parsed data. The target parsed data may be a file of a Document ObjectModel (DOM) tree, and the target parsed data may comprise a first label corresponding to the first object. The first label is a target label customized for the first object. In addition, the target parsed data may further comprise a third label corresponding to the third object, and the third label may be a label of a webpage component corresponding to the third object. The front-end control may render the first object and the third object based on the labels comprised in the target parsed data.

Then, in step 203, the second object is rendered by using the target client.

In this embodiment, the second object may comprise a second content of a second component. The second component may be a native component of the same type as the first component, or a native component of a different type than the first component. For example, if the first component is a content block, the second component may be a content block or another type of native component. This embodiment does not limit the specific type of the second component. The type of the second content may be different from the type of the first content. For example, if the first content is a file in a content block, the second content may comprise a non-file type of content in the content block (e.g. a text content in the content block), or the second content may comprise a content of another type of native component other than the content block. The second object may be rendered by using the target client.

At present, since the rendering performance of the front-end control is lower than that of the client, if the front-end control is used to render the contents of all the native components, the quality and efficiency of rendering will be reduced. If the client is used to render the contents of all the native components, there will be a problem of mutual coverage between the native component and the webpage component. According to the document processing method provided by the embodiments of the present disclosure, when the target document output by the target client is rendered, the front-end control embedded in the target client is used to render a first content of a portion of native components, and the target client is used to render a second content of another portion of the native components, thus achieving a partial same-layer rendering. Thus when the problem of mutual coverage between a native component and a webpage component is reduced, a decrease in the quality and efficiency of rendering is reduced, and the impact on some functions of the native components is also reduced.

In some embodiments, the first object corresponds to a target element in the target document. The target element may be an element corresponding to a preset string type. For example, the above pseudocode is taken as an example. The target element may be an element corresponding to the string type ‘drive_file_block_v2’.

Specifically, in the process of rendering the first object by using the front-end control embedded in the target client in step 202, the front-end control may first parse the target document to obtain string types corresponding to respective elements in the target document. If the preset string type corresponding to the target element is obtained, a target webpage component is created for the first object. For example, if the obtained string type corresponding to element ‘a’ is ‘drive_file_block_v2’, it is indicated that element ‘a’ is the target element. Element ‘a’ corresponds to the first object, so that the target webpage component may be created for the first object corresponding to element ‘a’.

Referring to the above pseudocode, the target webpage component may be created for the first object by inheriting a specified webpage element in the target document. Since inheriting the specified webpage element is to enable the created target webpage component to have the same function as the specified webpage element, the specified webpage element can be determined as needed. It can be understood that this embodiment does not limit the specific type of the specified webpage element.

After the target webpage component is created, a target label corresponding to the target webpage component is determined. The above pseudocode is taken as an example. The target label corresponding to the target webpage component may be ‘custom-component’. Then, in the process of generating the target parsed data, the target label corresponding to the target webpage component is embedded in the target parsed data. For example, the target label is embedded in the DOM tree corresponding to the target parsed data to obtain the target parsed data.

In some other embodiments, after the target parsed data is obtained, the method further comprises: binding a preset triggering event for the first object to a preset operation program. The target parsed data may comprise a DOM tree, and the preset triggering event for the first object may comprise a DOM event for the first object. Specifically, the preset triggering event for the first object may be a triggering event performed by a user on the first object, and the preset operation program may be an operation that the terminal device needs to perform in response to the preset triggering event. After the rendering is completed, if a user triggers the first object, the terminal device may run, in response to the preset triggering event for the first object, the preset operation program bound to the preset triggering event.

For example, the first object may be a video file in the document. The preset triggering event for the first object may be an operation of dragging and sliding a video progress bar. The preset operation program may be a program that adjusts a video progress based on the operation of dragging and sliding the video progress bar. The operation of dragging and sliding the video progress bar may be bound to the program that adjusts the video progress. After the rendering is completed, if a user performs the operation of dragging and sliding the video progress bar, the terminal device may run, in response to the triggering event of dragging and sliding the video progress bar, the program that adjusts the video progress.

Compared with a webpage component rendered by a front-end control, a native component rendered by a client is at a higher level. Therefore, the content of the webpage component rendered by the front-end control may be covered by the content of the native component rendered by the client, and may not respond properly to some triggering events. This embodiment binds the preset triggering event for the first object to the preset operation program, so that when the preset triggering event for the first object occurs, the preset operation program bound to the preset triggering event may run, thereby avoiding the problem of an incorrect response to the preset triggering event due to the mutual coverage between the native component and the webpage component.

It should be noted that although the operations of the method of the embodiments of the present disclosure are described in a specific order in the above embodiments, this does not require or imply that these operations need to be performed in this specific order, or that all the shown operations need to be performed to achieve desired results. On the contrary, the order of execution of the steps depicted in the flowcharts can be changed. Additionally or alternatively, some steps may be omitted; multiple steps may be combined into one step for execution; and/or a step may be decomposed into multiple steps for execution.

Corresponding to the foregoing document processing method embodiment, the present disclosure further provides a document processing apparatus embodiment.

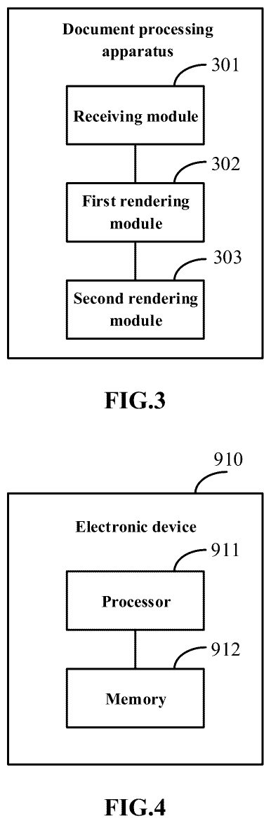

As shown in FIG. 3, FIG. 3 is a block diagram of a document processing apparatus shown according to an exemplary embodiment. The apparatus may comprise: a receiving module 301, a first rendering module 302, and a second rendering module 303.

The receiving module 301 is configured to receive a triggering operation for a target document, wherein the target document is output by a target client, the target document comprises a first object and a second object, and the first object comprises a first content of a first component;
the first rendering module 302 is configured to: in response to the triggering operation, render the first object by using a front-end control in the target client; and
the second rendering module 303 is configured to render the second object by using the target client, wherein the second object comprises a second content of a second component.

In some implementations, the first component comprises a target content block in the target document; and the first content comprises a file embedded in the target content block.

In some other implementations, the first rendering module 302 is configured to: obtain, by the front-end control, target parsed data based on the target document, wherein the target parsed data comprises a first label corresponding to the first object, and the first label is a target label customized for the first object; and render, by the front-end control, the first object based on the target parsed data.

In some other implementations, the first object corresponds to a target element in the target document; and the front-end control may obtain the target parsed data based on the target document through the following mode: parsing the target document to obtain string types corresponding to respective elements in the target document; in a case where a preset string type corresponding to the target element is obtained, creating a target webpage component for the first object; determining a target label corresponding to the target webpage component; and generating the target parsed data, wherein the target label is embedded in the target parsed data.

In some other implementations, the first rendering module 302 may create the target webpage component for the first object by the following mode: creating the target webpage component for the first object by inheriting a specified webpage element in the target document.

In some other implementations, the apparatus may further comprise: a binding module (not shown).

The binding module is configured to: after the target parsed data is obtained, bind a preset triggering event for the first object to a preset operation program.

In some other implementations, the target parsed data comprises a DOM tree, and the preset triggering event comprises a DOM event.

In some other implementations, the apparatus may further comprise: an execution module (not shown).

The execution module is configured to: after the rendering of the first object is completed, in response to the preset triggering event for the first object, run the preset operation program bound to the preset triggering event.

The apparatus embodiment basically corresponds to the method embodiment, so that for related parts, refer to some of the descriptions in the method embodiment. The apparatus embodiment described above is only schematic. The units described as separate parts may or may not be physically separate, and parts displayed as units may or may not be physical units, may be located in one position, or may be distributed on a plurality of network units. Some or all of the modules are selected according to actual needs to achieve the objective of the solution of the embodiments of the present disclosure. Those of ordinary skill in the art can understand and implement the present disclosure without creative work.

FIG. 4 is a schematic block diagram of an electronic device according to some embodiments of the present disclosure. As shown in FIG. 4, the electronic device 910 comprises a processor 911 and a memory 912 and may be configured to implement a client or a server. The memory 912 is used to non-instantaneously store computer-executable instructions (such as one or more computer program modules). The processor 911 is configured to execute the computer-executable instructions. The computer-executable instructions, when executed by the processor 911, may execute one or more steps of the document processing method described above, thereby implementing the document processing method described above. The memory 912 and the processor 911 may be interconnected through a bus system and/or a connecting mechanism (not shown) in another form.

For example, the processor 911 may be a central processing unit (CPU), a graphics processing unit (GPU), or a processing unit in another form with a data processing capability and/or a program running capability. For example, the CPU may be an X86 or ARM architecture, and the like. The processor 911 may be a general-purpose processor or a dedicated processor that can control other components in the electronic device 910 to perform desired functions.

For example, the memory 912 may comprise any combination of one or more computer program products, and the computer program product may comprise computer-readable storage media in various forms, such as a volatile memory and/or a non-volatile memory. The volatile memory may comprise, for example, a random access memory (RAM) and/or a cache. The non-volatile memory may comprise, for example, a read-only memory (ROM), a hard disk drive, an erasable programmable read-only memory (EPROM), a portable compact disc read-only memory (CD-ROM), a USB memory, a flash memory, and the like. One or more computer program modules may be stored on a computer-readable storage medium. The processor 911 may run one or more computer program modules to implement the various functions of the electronic device 910. The computer-readable storage medium may further store various application programs and data, and various data used and/or generated by the application programs.

It should be noted that in the embodiments of the present disclosure, the specific functions and technical effects of the electronic device 910 may be found in the description of the document processing method above, and will not be elaborated here.

FIG. 5 is a schematic block diagram of another electronic device according to some embodiments of the present disclosure. The electronic device 920 is suitable for, for example, implementing the document processing method provided by the embodiments of the present disclosure. The electronic device 920 may be a terminal device or the like, and may be configured to implement a client or a server. The electronic device 920 may comprise, but is not limited to, a mobile terminal such as a mobile phone, a laptop, a digital broadcast receiver, a Personal Digital Assistant (PDA), a Portable Android Device (PAD), a Portable Media Player (PMP), a in-vehicle terminal (e.g., an in-vehicle navigation terminal), and a wearable electronic device, and a fixed terminal such as a digital television (TV), a desktop computer, and a smart home device. It should be noted that the electronic device 920 shown in FIG. 5 is only an example and may not impose any limitations on the function and scope of use of the embodiments of the present disclosure.

As shown in FIG. 5, the electronic device 920 may comprise a processing apparatus (such as a central processing unit and graphics processing unit) 921 that may perform various appropriate actions and processing according to programs stored in a ROM 922 or loaded from a storage apparatus 928 to a RAM 923. Various programs and data required for operations of the electronic device 920 may also be stored in the RAM 923. The processing apparatus 921, the ROM 922, and the RAM 923 are connected to each other through a bus 924. An Input/Output (I/O) interface 925 is also connected to a bus 924.

Usually, following apparatuses may be connected to the I/O interface 925: an input apparatus 926 including a touch screen, a touchpad, a keyboard, a mouse, a camera, a microphone, an accelerometer, a gyroscope, and the like; an output apparatus 927 including a Liquid Crystal Display (LCD), a speaker, a vibrator, and the like; a storage apparatus 928 including a magnetic tape, a hard disk drive, and the like; and a communication apparatus 929. The communication apparatus 929 may allow the electronic device 920 to wirelessly or wiredly communicate with other electronic devices to exchange data. Although FIG. 5 shows the electronic device 920 with various apparatuses, it should be understood that the electronic device 500 is not required to implement or have all the apparatuses shown. The electronic device 920 may alternatively implement or have more or fewer apparatuses.

For example, according to the embodiments of the present disclosure, the above document processing method may be implemented as a computer software program. For example, the embodiments of the present disclosure comprise a computer program product, including a computer program carried on a non-transitory computer-readable medium, and the computer program comprises program codes used for performing the above document processing method. In such an embodiment, the computer program may be downloaded and installed from a network through the communication apparatus 929, or installed from the storage apparatus 928, or installed from the ROM 922. When the computer program is run by the processing apparatus 921, the functions defined in the document processing method provided by the embodiments of the present disclosure may be achieved.

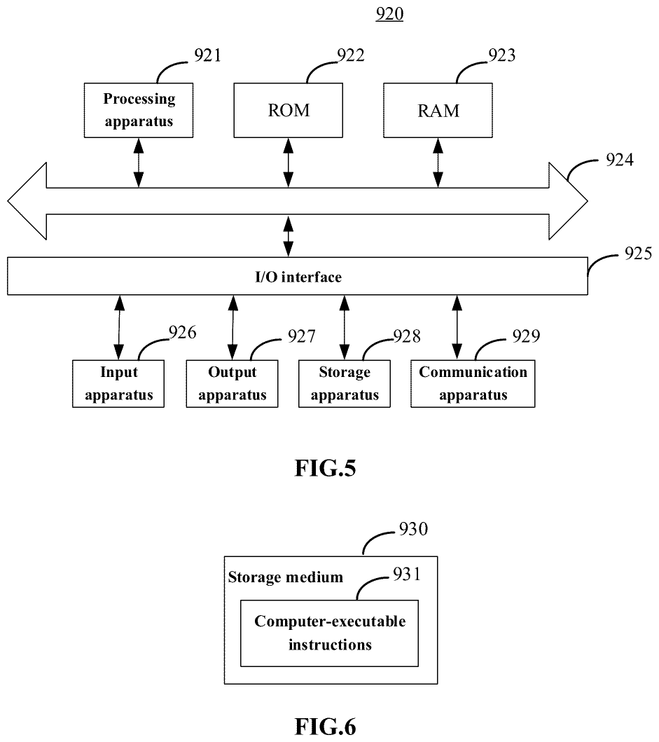

FIG. 6 is a schematic diagram of a storage medium according to some embodiments of the present disclosure. For example, as shown in FIG. 6, the storage medium 930 may be a non-transitory computer-readable storage medium used for storing non-transitory computer-executable instructions 931. When the non-transitory computer-executable instructions 931 are executed by a processor, the document processing method provided by the embodiments of the present disclosure may be implemented. For example, when the non-transitory computer-executable instructions 931 are executed by the processor, one or more steps of the above document processing method may be executed.

For example, the storage medium 930 may be applied to the above electronic device. For example, the storage medium 930 may comprise the memory in the electronic device.

For example, the storage medium may comprise a storage card of a smartphone, a storage component of a tablet, a hard drive disk of a personal computer, a RAM, a ROM, an EPROM, a CD-ROM, a flash memory, or any combination of the aforementioned storage media, or may be other suitable storage media.

For example, the explanation of the storage medium 930 may be found in the description of the memory in the embodiments of the electronic device, and any repetition will be omitted. The specific functions and technical effects of the storage medium 930 may be found in the description of the document processing method above, and will not be elaborated here.

It should be noted that in the context of the present disclosure, the computer-readable medium may be a tangible medium that may comprise or store a program for use by an instruction execution system, apparatus, or device or in connection with the instruction execution system, apparatus, or device. The computer-readable medium may be a computer-readable signal medium, a computer-readable storage medium, or any combination of the computer-readable signal medium and the computer-readable storage medium. The computer-readable storage medium may be, for example, but not limited to, electric, magnetic, optical, electromagnetic, infrared, or semiconductor systems, apparatuses, or devices, or any combination of the above. More specific examples of the computer-readable storage medium may comprise, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal media may comprise data signals propagated in a baseband or as part of a carrier wave, which carries computer-readable program codes. The propagated data signals may be in various forms, including but not limited to: electromagnetic signals, optical signals, or any suitable combination of the above. The computer-readable signal medium may also be any computer-readable medium other than a computer-readable storage medium. The computer-readable signal medium may send, propagate, or transmit programs for use by or in combination with an instruction execution system, apparatus, or device. The program codes contained in the computer-readable medium may be transmitted using any suitable medium, including but are not limited to: a wire, an optical cable, a Radio Frequency (RF), and the like, or any suitable combination of the above.

Those skilled in the art will easily come up with other implementations of the present disclosure after considering this specification and implementing the invention disclosed herein. The present disclosure aims to cover any variations, uses, or adaptive changes of the present disclosure, and these variations, uses, or adaptive changes follow the general principles of the present disclosure and comprise common knowledge or customary technical means in the technical field that are not disclosed herein. The specification and the embodiments are considered as merely exemplary, and the scope and spirit of the present disclosure are pointed out in the claims.

It should be understood that the present disclosure is not limited to the precise structures that have been described above and shown in the drawings, and various modifications and changes may be made without departing from the scope of the present disclosure. The scope of the present disclosure is subject only to the appended claims.

I/We claim:

1. A document processing method, comprising:
receiving a triggering operation for a target document, wherein the target document is output by a target client, the target document comprises a first object and a second object, and the first object comprises a first content of a first component;
in response to the triggering operation, rendering the first object by using a front-end control in the target client; and
rendering the second object by using the target client, wherein the second object comprises a second content of a second component.

2. The method according to claim 1, wherein the first component comprises a target content block in the target document; and the first content comprises a file embedded in the target content block.

3. The method according to claim 1, wherein rendering the first object by using the front-end control in the target client comprises:
obtaining, by the front-end control, target parsed data based on the target document, wherein the target parsed data comprises a first label corresponding to the first object, and the first label is a target label customized for the first object; and
rendering, by the front-end control, the first object based on the target parsed data.

4. The method according to claim 3, wherein the first object corresponds to a target element in the target document; and the front-end control obtains the target parsed data based on the target document by:
parsing the target document to obtain string types corresponding to respective elements in the target document;
in a case where a preset string type corresponding to the target element is obtained, creating a target webpage component for the first object;
determining a target label corresponding to the target webpage component; and
generating the target parsed data, wherein the target label is embedded in the target parsed data.

5. The method according to claim 4, wherein creating the target webpage component for the first object comprises: creating the target webpage component for the first object by inheriting a specified webpage element in the target document.

6. The method according to claim 3, wherein the method further comprises, after obtaining the target parsed data, binding a preset triggering event for the first object to a preset operation program.

7. The method according to claim 6, wherein the target parsed data comprises a DOM tree, and the preset triggering event comprises a DOM event.

8. The method according to claim 6, wherein the method further comprises:
after the rendering of the first object is completed, running, in response to the preset triggering event for the first object, the preset operation program bound to the preset triggering event.

9. A non-transitory computer-readable storage medium with a computer program stored thereon, wherein the computer program, when run in a computer, causes the computer to:
receive a triggering operation for a target document, wherein the target document is output by a target client, the target document comprises a first object and a second object, and the first object comprises a first content of a first component;
in response to the triggering operation, render the first object by using a front-end control in the target client; and
render the second object by using the target client, wherein the second object comprises a second content of a second component.

10. The non-transitory computer-readable storage medium according to claim 9, wherein the first component comprises a target content block in the target document; and the first content comprises a file embedded in the target content block.

11. The non-transitory computer-readable storage medium according to claim 9, wherein the computer being caused to render the first object by using the front-end control in the target client comprises being caused to:
obtain, by the front-end control, target parsed data based on the target document, wherein the target parsed data comprises a first label corresponding to the first object, and the first label is a target label customized for the first object; and
render, by the front-end control, the first object based on the target parsed data.

12. The non-transitory computer-readable storage medium according to claim 11, wherein the first object corresponds to a target element in the target document; and the front-end control obtains the target parsed data based on the target document by:
parsing the target document to obtain string types corresponding to respective elements in the target document;
in a case where a preset string type corresponding to the target element is obtained, creating a target webpage component for the first object;
determining a target label corresponding to the target webpage component; and
generating the target parsed data, wherein the target label is embedded in the target parsed data.

13. An electronic device comprising a memory and a processor, wherein the memory stores executable codes, and the executable codes, when executed by the processor, cause the processor to:
receive a triggering operation for a target document, wherein the target document is output by a target client, the target document comprises a first object and a second object, and the first object comprises a first content of a first component;
in response to the triggering operation, render the first object by using a front-end control in the target client; and
render the second object by using the target client, wherein the second object comprises a second content of a second component.

14. The electronic device according to claim 13, wherein the first component comprises a target content block in the target document; and the first content comprises a file embedded in the target content block.

15. The electronic device according to claim 13, wherein the processor being caused to render the first object by using the front-end control in the target client comprises being caused to:
obtain, by the front-end control, target parsed data based on the target document, wherein the target parsed data comprises a first label corresponding to the first object, and the first label is a target label customized for the first object; and
render, by the front-end control, the first object based on the target parsed data.

16. The electronic device according to claim 15, wherein the first object corresponds to a target element in the target document; and the front-end control obtains the target parsed data based on the target document by:
parsing the target document to obtain string types corresponding to respective elements in the target document;
in a case where a preset string type corresponding to the target element is obtained, creating a target webpage component for the first object;
determining a target label corresponding to the target webpage component; and
generating the target parsed data, wherein the target label is embedded in the target parsed data.

17. The electronic device according to claim 16, wherein creating the target webpage component for the first object comprises: creating the target webpage component for the first object by inheriting a specified webpage element in the target document.

18. The electronic device according to claim 15, wherein the processor is further caused to, after obtaining the target parsed data, bind a preset triggering event for the first object to a preset operation program.

19. The electronic device according to claim 18, wherein the target parsed data comprises a DOM tree, and the preset triggering event comprises a DOM event.

20. The electronic device according to claim 18, wherein the processor is further caused to:
after the rendering of the first object is completed, run, in response to the preset triggering event for the first object, the preset operation program bound to the preset triggering event.
